(19) United States
(12) Patent Application Publication
(10) Pub. No.: US 2003/0070099 A1
(43) Pub. Date: Apr. 10, 2003

(54) System and methods for protection of data stored on a storage medium device

(76) Inventors: Jeffrey D. Schwartz, Loveland, CO (US); Troy Roberts, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/971,513

(22) Filed: Oct. 5, 2001

(51) Int. Cl. H04L 9/32

(52) U.S. Cl. 713/202; 713/1

(57) ABSTRACT

In one embodiment, the present invention is directed to a system for protecting content stored on a storage medium device. The system may comprise: a processor for executing code to access a user password and a recorded serial number; a storage medium device, the storage medium device being operable to return its associated serial number, and the storage medium device providing a device interface that requires the password to access data stored on the storage medium device; and code for booting the system, wherein the code for booting comprises: code for requesting the storage medium device to return its associated serial number; code for comparing the serial number returned by the storage medium device against the recorded serial number; and code for providing the user password to the storage medium device when the code for comparing determines that the serial number returned by the storage medium device matches the recorded serial number.

### TECHNICAL FIELD

The present invention is related to data storage and more particularly to a system and methods for protection of data stored on a storage medium device.

### BACKGROUND

Various interface standards have been developed to provide a communication interface between a storage peripheral (e.g., a hard drive) and a host system. A prominent standard for interfacing hard disk drives is commonly known as AT Attachment (ATA). A significant number of other names are also used to identify variations on the ATA standard, including ATA/AT Attachment Packet Interface (ATAPI), Integrated Drive Electronics (IDE), Enhanced IDE (EIDE), ATA-2, Fast ATA, ATA-3, Ultra ATA, Ultra DMA, and the like. A recent draft of proposed modifications to the ATA standard is described in the T13 1321D standard document entitled “Information Technology—AT Attachment with Packet Interface—5 (ATA/ATAPI-5),” which is available from working group T13 (a Technical Committee of Accredited Standards Committee NCITS). The document is also available via the website (http://www.t13.org/project/d1321r3.pdf) of working group T13.

The ATA interface appreciably increases the performance, reliability, and compatibility of hard disk drive peripherals. The ATA interface achieves these improvements by integrating the disk drive and the drive controller. Due to the advantages of the ATA interface, a majority of hard disk drives used by modern personal computers (PCs) implement an ATA interface.

The ATA standard (as well as other disk drive interfaces) defines an optional security mode feature that is designed to protect user-based systems. The security mode restricts access to user data stored on the disk medium. The security feature is enabled by sending a user password to the disk drive controller with the SECURITY SET PASSWORD command. When the security system is enabled, access to user data on the device is denied after a power cycle until the user password is sent to the disk drive controller with the SECURITY UNLOCK command.

Additionally, the user password may be changed after the SECURITY UNLOCK command. To prevent a password changing attack by a hacker, a SECURITY FREEZE LOCK command is defined. The SECURITY FREEZE LOCK command prevents changes to passwords until the next power cycle. However, user data on the disk medium may still be accessed.

The ATA standard also defines a master password according to its security scheme. The master password may be utilized to unlock the disk drive when the user password is forgotten by the user. The effect of the master password is dependent on the security mode of the disk drive. If the security mode was previously set to HIGH, submission of the master password with the SECURITY UNLOCK command will cause the disk drive to be unlocked. Also, the user password may be changed when the disk drive is unlocked. If the security mode was previously set to maximum, submission of the master password with the SECURITY ERASE UNIT command will unlock the disk drive. However, the SECURITY ERASE UNIT command will also erase all user data on the disk medium.

The various commands associated with the user password and the master password are completed by presenting a user interface on the host system. Specifically, the operating system will typically allow an administrator to set the user password via a user interface. Thereafter, the operating system will present another user interface to a user during the boot process. The user interface will request the password from the user. The password will then be passed to the disk drive controller with the SECURITY UNLOCK command. By implementing the forgoing, ATA compatible drives may prevent an unauthorized hacker from examining the files of another user.

The ATA interface is problematic because manual intervention is typically used to invoke its security mode. Specifically, a system administrator sets the user password and master password and invokes the desired security mode. The system administrator is also required to maintain recordation of the passwords to prevent the disk drive from becoming unusable. Moreover, a user must be present and the user must remember the password to allow a system incorporating the disk drive to conduct boot operations.

### BRIEF SUMMARY OF THE INVENTION

In one embodiment, the present invention is directed to a system for protecting content stored on a storage medium device. The system may comprise: a processor for executing code to access a user password and a recorded serial number; a storage medium device, the storage medium device being operable to return its associated serial number, and the storage medium device providing a device interface that requires the password to access data stored on the storage medium device; and code for booting the system, wherein the code for booting comprises: code for requesting the storage medium device to return its associated serial number; code for comparing the serial number returned by the storage medium device against the recorded serial number; and code for providing the user password to the storage medium device when the code for comparing determines that the serial number returned by the storage medium device matches the recorded serial number.

### BRIEF DESCRIPTION OF THE DRAWINGS

FIG. 1 depicts a block diagram of an exemplary system which may implement embodiments of the present invention.

FIGS. 2A and 2B depict an exemplary flowchart of steps according to embodiments of the present invention.

### DETAILED DESCRIPTION OF THE INVENTION

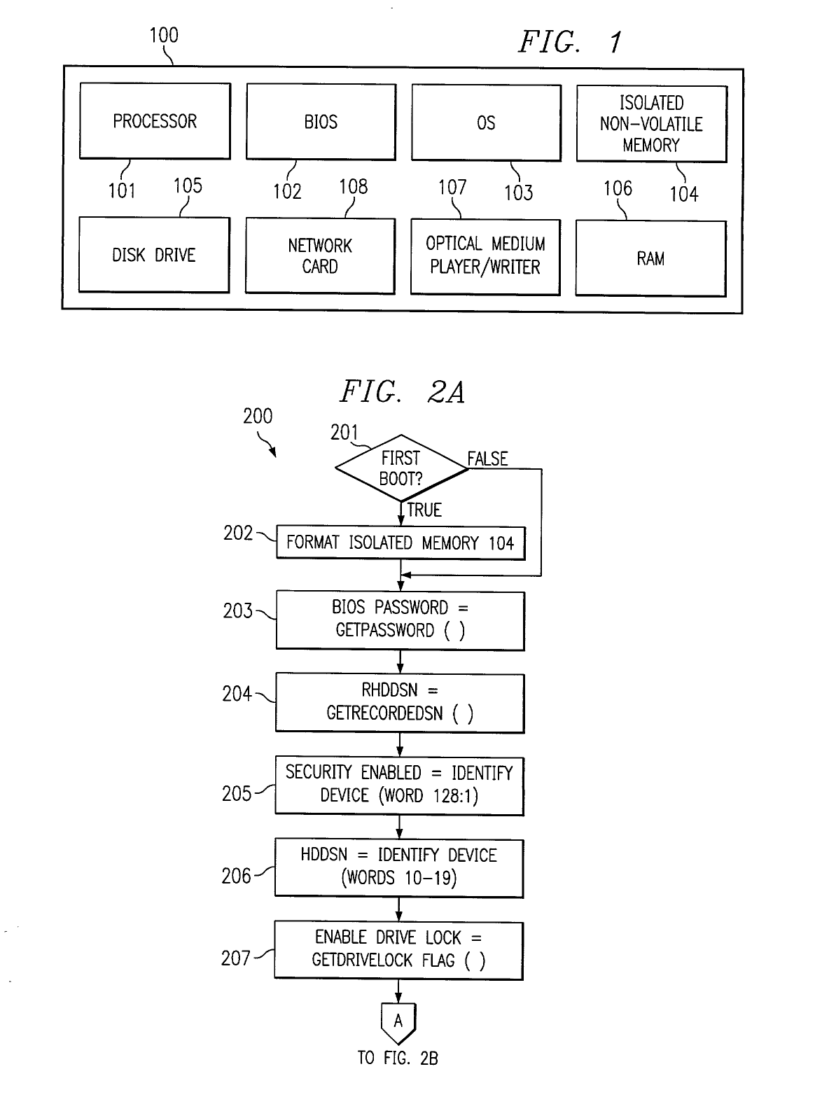

FIG. 1 depicts a block diagram of exemplary system 100 that may implement embodiments of the present invention. In accordance with embodiments of the present invention, system 100 may be operated as a non-user based system. Specifically, system 100 may execute various functions without regard to the specific user. For example, system 100 may implement multimedia applications that do not require restricting access to user data Alternatively, system 100 may implement an Internet browser application that may not require restricting access to user data. Although the embodiments of the present invention may be implemented on non-user-based systems, the present invention is not limited to non-user-based system. Embodiments of the present invention may be implemented on any suitable processor-based system that utilizes a user password to access data.

System 100 may comprise processor 101 to execute code that defines the functionality of system 100. Processor 101 may be any general purpose processor. Suitable processors, without limitation, include processors from the ITANIUM family of processors and RISC processors. However, the present invention is not restricted by the architecture of processor 101 as long as processor 101 supports the inventive operations as described herein.

System 100 may include basic input/output system (BIOS) 102. BIOS 102 is built-in software that determines the lowest level functionality of system 100. For example, BIOS 102 may comprise the code to control the keyboard, display screen, disk drives, serial communications, and a number of miscellaneous functions.

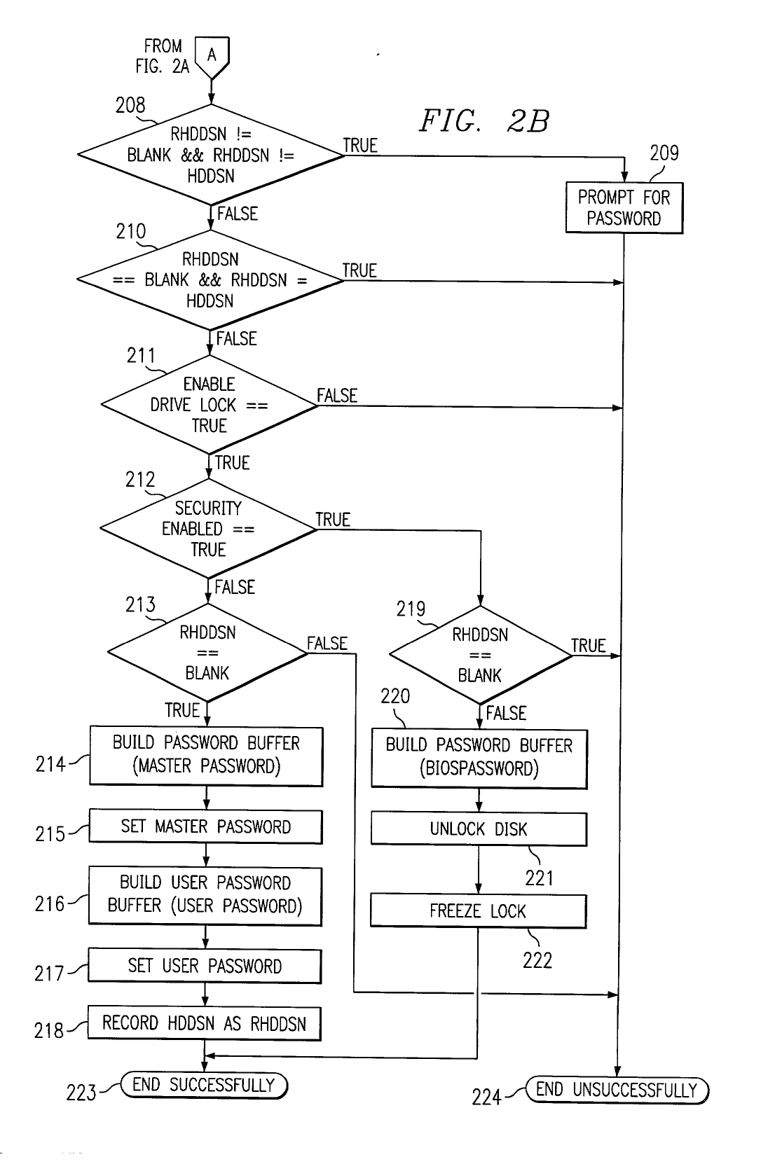

Additionally, according to embodiments of the present invention, BIOS 102 preferably comprises a drive lock algorithm as will be discussed in greater detail with respect to FIGS. 2A and 2B. Also, the drive lock algorithm preferably utilizes isolated non-volatile memory 104 (e.g., flash memory) to maintain state information. Isolated non-volatile memory 104 may be a physically separate flash memory chip. Alternatively, isolated non-volatile memory 104 may be contained in a flash-memory chip that also stores other information. In that case, the portion of the common chip that constitutes isolated non-volatile memory 104 may be hidden from hackers by randomly locating isolated non-volatile memory 104 in the common flash memory chip.

BIOS 102 may be implemented in a read only memory (ROM) chip or on a flash memory chip. BIOS 102 also makes it possible for a computer to boot itself. Because random access memory (RAM) 106 is faster than ROM, the software instructions or code of BIOS 102 may be copied into RAM 106 for improved execution performance.

System 100 may further comprise operating system 103. Operating system 103 may be installed on disk drive 105. Operating system 103 or a portion thereof (if dynamically loadable kernel is utilized) may be loaded into RAM 106 during boot procedures. Operating system 103 manages all other programs or applications executing on system 100. Operating system 103 may perform thread management, manage internal memory, control input/output (I/O) operations, and/or the like.

Additionally, operating system 103 may provide lower level functionality that may be accessed by other programs or applications. For example, operating system 103 may comprise a kernel. Other programs may access the kernel by performing system calls. A program may perform a system call to access a file stored on an optical medium placed in optical medium player/writer 107. Similarly, a program may perform a system call to establish a transmission control protocol/Internet protocol (TCP/IP) connection with a remote web server via network card 108.

Operating system 103 may also prevent other programs or applications from performing undesirable tasks. For example, operating system 103 may comprise code to prevent a user from copying audio content to an optical medium via optical medium player/writer 107 in an unauthorized manner. For example, operating system 103 may examine a digital “watermark” in the audio content to determine if the audio content has been obtained in an authorized manner. A digital watermark is encoded information in audio content that is imperceptible to a listener but is retrievable by digital signal processing according to a predefined scheme. The encoded information may specify a particular system or user that is authorized to access the audio content according to licensing terms. If the digital watermark indicates that the content has not been accessed according to licensing terms associated with the digital watermark, operating system 103 may prevent the audio content from being written to the optical medium.

As another example, operating system 103 may comprise other protections to limit the operations of system 100. Operating system 103 may comprise code to prevent misuse on the Internet. Operating system 103 may comprise networking routines that prevent applications from performing “denial-of-service” attacks. Denial of service attacks involve sending large numbers of hypertext transfer protocol (HTTP) requests to a web server. The web server is overwhelmed by the received HTTP requests from the denial-of-service attack and cannot respond to legitimate requests. Operating system 103 may prevent denial-of-service attacks from being launched from system 100 by limiting the number of HTTP requests sent to a particular IP address over a particular period of time.

Because operating system 103 implements application-limiting functionality, operating system 103 preferably comprises code to prevent modification of operating system 103. For example, operating system 103 may prevent a user from attempting to rewrite the files that comprise the kernel routines of operating system 103 stored on disk drive 105. This may occur by refusing to accept commands or system calls to write to certain subdirectories. However, this is only a partial solution to prevent misuse of system 100. Specifically, a hacker may simply place another disk drive 105 into system 100 that contains a different operating system. Alternatively, a hacker may remove disk drive 105 and place it into another system that does not implement subdirectory writing restrictions. The other system may be utilized to rewrite the various files on disk drive 105. The altered medium of disk drive 105 may be replaced into system 100 without the application-limiting functionality.

According to embodiments of the present invention, a drive lock algorithm prevents a hacker from altering operating system 103. The drive lock algorithm is preferably implemented in BIOS 102 and is executed during boot operations of system 100. Also, the drive lock algorithm may be utilized when disk drive 105 implements the security mode features of the ATA standard. Although embodiments of the present invention are described in connection with an ATA interface, it shall be appreciated that the present invention is not limited to ATA disk drive interfaces. Any suitable protocol for restricting access to disk drive 105 via the interface with disk drive 105 may be utilized.

For the convenience of the reader, it is appropriate to define several system states and variables to describe the operations of the drive lock algorithm. HDDSN is the serial number reported by the current disk drive 105 in the response to the ATA-3 IDENTIFY DEVICE command. RHDDSN is a value stored in isolated non-volatile memory 104 to identify the serial number of a disk drive 105 that is properly associated with system 100. BIOSPASSWORD is the user password stored in isolated non-volatile memory 104. The current disk drive 105 reports flag SECURITY ENABLED to indicate whether the security mode of disk drive 105 has been enabled. ENABLE DRIVE LOCK is a flag stored in isolated non-volatile memory 104 that specifies whether the security operations of the drive lock algorithm should be executed. It shall be appreciated that the names of the system states and variables are only exemplary. The present invention is not limited to the preceding identifiers.

Exemplary steps to implement the drive lock algorithm according to embodiments of the present invention are shown in flowchart 200 of FIGS. 2A and 2B. In step 201, a logical comparison is made to determine whether the current boot is the first boot of system 100. If the current boot is not the first boot, the process flow proceeds to step 203. If the current boot is the first boot, the process flow proceeds to step 202. In step 202, the drive lock algorithm formats isolated non-volatile memory 104 by, for example, filling each byte of isolated non-volatile memory 104 with a predetermined hexadecimal value (e.g., 0×FF). Formatting isolated non-volatile memory 104 prevents “garbage” values initially present in isolated non-volatile memory 104 from being confused with actual values created pursuant to the drive lock algorithm of the present invention.

Step 203 begins a series of operations to retrieve various information that is used to perform the logical comparisons of the drive lock algorithm. In step 203, the BIOSPASSWORD value is retrieved. The BIOSPASSWORD is the password stored in isolated non-volatile memory 104 that may be eventually passed to disk drive 105. In step 204, the value RHDDSN is retrieved from isolated non-volatile memory 104. In step 205, the SECURITY ENABLED flag is determined by sending an appropriate command to disk drive 105. According to the ATA protocol, this flag is the first bit of word 128 of the return package associated with the IDENTIFY DEVICE command. In step 206, HDDSN is retrieved from words 10-19 of the return package associated with the IDENTIFY DEVICE command. In step 207, ENABLE DRIVE LOCK flag is determined from the value stored in isolated non-volatile memory 104.

In step 208, a logical comparison is made to eliminate invalid states. The logical comparison determines whether RHDDSN is not blank (where blank, in this example, means each byte of RHDDSN is filled with the hexadecimal value 0×FF) and whether RHDDSN does not equal HDDSN. This logical comparison causes the process flow to skip the lock/unlock process for invalid states. Specifically, booting of system 100 will be disallowed when a current disk drive 105 is placed in system 100 that possesses a HDDSN that does not match the RHDDSN. If the logical comparison generates a true value, the process flow proceeds to step 209. In step 209, a security protocol may be initialized to enable replacement of disk drive 105 by, for example, receiving an appropriate administrator password. Otherwise, the booting process may be terminated as unsuccessful by proceeding to step 224.

If the logical comparison of step 208 produces a false value, another logical comparison is made in step 210. In step 210, the logical comparison determines whether RHDDSN is blank and whether RHDDSN equals HDDSN. This eliminates states that may be used by a hacker to attempt to circumvent the drive lock algorithm. Specifically, in the present example, disk drive 105 should never report a serial number of all 0×FF values. Accordingly, this state may indicate that a hacker has attempted to rewrite flash memory associated with disk drive 105. If the logical comparison produces a true state, the process flow ends as unsuccessful by proceeding to step 224.

If the logical comparison of step 210 produces a false value, the process flow proceeds to step 211 where another logical comparison is made. In step 211, the logical comparison determines whether the value of ENABLE DRIVE LOCK flag is true. If logical comparison produces a false value (i.e., ENABLE DRIVE LOCK is false), the process flow ends unsuccessfully by proceeding to step 224 (i.e., disk drive 105 is not locked or unlocked without this flag being set).

ENABLE DRIVE LOCK may preferably be initialized to contain a false value. ENABLE DRIVE LOCK may be modified to contain a true value when, for example, operating system 103 is installed on disk drive 105 via a CD-ROM. After installation of operating system 103, the drive lock algorithm may secure the executable files by proceeding with the process flow to step 212.

If the logical comparison of step 211 produces a true value (i.e., ENABLE DRIVE LOCK is true), another logical comparison is made in step 212. In step 212, the logical comparison determines whether the SECURITY ENABLED flag is true. If the logical comparison of step 212 produces a false value (i.e., SECURITY ENABLED is false), the process flow proceeds to step 213 to initialize the security mode of disk drive 105. In step 213, a logical comparison is made to determine whether RHDSSN is blank. If the logical comparison of step 212 produces a true value (i.e., SECURITY ENABLED is true), the process flow ends unsuccessfully by proceeding to step 224, because this is an invalid state.

If the logical comparison of step 213 produces a true value, the process flow proceeds to step 214. In step 214, a buffer is built that will load the master password into disk drive 105 according to the security mode scheme. The master password is preferably the same for each system 100 of a set of systems 100 manufactured during a common interval. In step 215, the master password is set on disk drive 105 according to the security mode scheme by providing the password with the appropriate command. In step 216, a buffer is built to hold the user password according to the security mode scheme. The user password is preferably unique to each system 100. The actual value of the user password is not important.

In an embodiment, the user password may be automatically generated by an external system and retained in a database for future reference. The external system may communicate the password to BIOS 102 during boot operations pursuant to manufacture of system 100. Other information may be communicated to system 100 at the same time as the password. An exemplary set of such information may contain a visible serial number (VSN) that is visible on the external surface of system 100, a hidden serial number (HSN), a encryption serial number (ESN) used to encrypt/decrypt secure transfers (where the ESN is preferably not seen on the Internet), and BIOSPASSWORD. Each of VSN, HSN, ESN, and BIOSPASSWORD may be retained in a database. The drive lock algorithm and/or other security protocols may be activated upon receipt of such information.

In step 217, the user password is set by sending the password to disk drive 105 with the appropriate command and by writing the user password into isolated non-volatile memory 104 in the BIOSPASSWORD location. In step 218, the serial number (HDDSN) retrieved from disk drive 105 is written into isolated non-volatile memory 104 as the location that stores the value of RHDDSN.

Accordingly, steps 214 through 218 are operable to associate a particular disk drive 105 with a particular system 100. Specifically, the disk drive 105 will not be accessible by another computer system and disk drive 105 cannot be replaced in system 100 with another unit to circumvent the application-limiting functionality. From step 218, the process flow ends as successful by proceeding to step 223.

If the logical comparison of step 212 produces a true value, the process flow proceeds to step 219 where another logical comparison is made. In step 219, the logical comparison determines whether RHDDSN is blank. If the logical comparison produces a true value (i.e., RHDDSN, in the present example, is filled with 0×FF values), an invalid state has been detected and the process flow ends as unsuccessful by proceeding to step 224. If the logical comparison of step 212 produces a false value (i.e., RHDDSN is not filled with 0×FF values in the present example), a password buffer is built to contain BIOSPASSWORD stored in isolated non-volatile memory 104 (step 220). The password is passed to disk drive 105 with the appropriate SECURITY UNLOCK command (step 221). In step 222, the FREEZE LOCK command is sent to disk drive 105 to prevent the passwords from being changed until the next power cycle.

In step 223, the process flow of the drive lock algorithm ends as successful. BIOS 102 may continue the booting process by, for example, loading operating system 103 or a portion thereof into RAM 106. Alternatively, in step 224, the process flow of the drive lock ends unsuccessfully. BIOS 102 may perform other tasks or other protocols depending on the states that caused the drive lock algorithm to unsuccessfully end. Additionally or alternatively, BIOS 102 may terminate the boot operations after step 224.

It shall be appreciated that embodiments of the present invention may provide several advantages. First, unlike the typical security mode scheme employed by, for example, the ATA interface, a user is not required to remember the password. Embodiments of the present invention are preferably operable to retrieve the password from isolated non-volatile memory 104. Accordingly, embodiments of the present invention are operable to autonomously operate without the interaction of a user.

Additionally, it shall be appreciated that the result of this operation is appreciably different than the operations of typical password protection systems. Particularly, existing password protection systems are designed to only permit authorized users to access user files. However, embodiments of the present invention assume that anyone may operate system 100 and/or any user may read the files on disk drive 105. Instead, embodiments of the present invention prevent users from modifying executable files stored on disk drive 105 via the drive lock algorithm. Embodiments are operable to prevent users from booting system 100 with unauthorized executable files by implementing a suitable drive lock algorithm in BIOS 102. When booting system 100, BIOS 105 will not enable the system to operate unless disk drive 105 returns a serial number that is expected to equal a value stored in isolated non-volatile memory 104. Accordingly, a hacker cannot simply replace disk drive 105 to circumvent the application-limiting functionality. Moreover, a hacker cannot remove disk drive 105 to be modified via another system. Specifically, the hacker will not know the user password. Accordingly, the hacker will not be able to access disk drive 105 on another system to rewrite the operating system or other files.

1. A system for protecting content stored on a storage medium device, comprising:
a processor for executing code to access a user password and a recorded serial number;
a storage medium device, said storage medium device being operable to return its associated serial number, and said storage medium device providing a device interface that requires said password to access data stored on said storage medium device; and
code for booting said system, wherein said code for booting comprises:
code for requesting said storage medium device to return its associated serial number;
code for comparing said serial number returned by said storage medium device against said recorded serial number; and
code for providing said user password to said storage medium device when said code for comparing determines that said serial number returned by said storage medium device matches said recorded serial number.

2. The system of claim 1 wherein said storage medium device stores executable files of an operating system.

3. The system of claim 2 wherein said operating system rejects commands to modify executable files of said operating system.

4. The system of claim 1 wherein said user password and said recorded serial number are stored in non-volatile memory.

5. The system of claim 4 wherein said non-volatile memory is flash memory.

6. The system of claim 1 wherein said code for booting further comprises:
code for setting said user password by issuing a command to said storage device medium.

7. The system of claim 1 wherein said code for booting further comprises:
code for receiving said user password from an external system.

8. The system of claim 1 wherein said code for booting further comprises:
code for issuing a command to said storage medium device to prevent password changes from occurring until a next power cycle.

9. A method for protecting content stored on a storage medium device, wherein said method is implemented by processor-executable instructions, comprising:
retrieving a user password;
retrieving a recorded serial number;
querying a storage medium device to obtain a serial number of said storage medium device;
comparing said obtained serial number to said retrieved recorded serial number; and
when said obtained serial number equals said retrieved recorded serial number, providing said user password to said storage medium device to unlock data access to said storage medium device.

10. The method of claim 9 wherein said steps of retrieving a user password, retrieving a recorded serial number, querying, comparing, and providing are performed by basic input/output (BIOS) instructions.

11. The method of claim 9 wherein said steps of retrieving a user password, retrieving a recorded serial number, querying, comparing, and providing are performed during boot operations.

12. The method of claim 11 wherein said storage medium device stores executable files of an operating system.

13. The method of claim 12 further comprising:
preventing modification of executable files of said operating system.

14. The method of claim 9 wherein said user password and said recorded serial number are stored in non-volatile memory.

15. The method of claim 14 wherein said non-volatile memory is flash memory.

16. The method of claim 9 further comprising:
setting said user password by issuing a command to said storage device medium.

17. The method of claim 9 wherein said user password is initially created by an external system that maintains a database of user passwords.

18. The method of claim 9 further comprising:
issuing a command to said storage medium device to prevent password changes from occurring until a next power cycle.

19. A method for protecting data associated with a computer system, wherein said method is at least partially implemented in a basis input/output system (BIOS) of said computer system, said method comprising:
automatically generating a user password, wherein said user password is passed to a storage medium device to access data stored on said storage medium device;
storing said user password in non-volatile memory; and
executing software stored in said BIOS during boot operations of said computer system, wherein said step of executing software passes said user password to said storage medium device.

20. The method of claim 19 wherein said step of executing software further comprises:
receiving a serial number from said storage medium device.

21. The method of claim 20 wherein said step of executing software further comprises:
comparing said received serial number to a recorded serial number stored in said nonvolatile memory.

22. The method of claim 19 wherein said step of executing software only passes said user password to said storage medium device when a received serial number equals said recorded serial number.

23. The method of claim 19 further comprising:
preventing a user from modifying operating system files.
